(19) United States
(12) Patent Application Publication
(10) Pub. No.: US 2002/0117544 A1
(43) Pub. Date: Aug. 29, 2002

(54) Personal pricing system

(75) Inventors: Terrence Wolf, Venice, FL (US); Peter Davis, Dearborn, MI (US); Gary Hanlin, Dearborn, MI (US)

Correspondence Address: William G.Abbatt, Brooks & Kushman P.C, 1000 Town Center, 22nd Floor, Southfield, MI, 48075-1351, US

(73) Assignee: Quicksystems LLC, Dearborn, MI

(21) Appl. No.: 09/992,579

(22) Filed: Nov. 16, 2001

Related U.S. Application Data
(60) Provisional application No. 60/249,501, filed on Nov. 17, 2000.

(51) Int. Cl. G06K 15/00

(52) U.S. Cl. 235/383

(57) ABSTRACT

A pricing device, method and system that serve as electronic coupons which replace paper coupons which are widely used in advertising discounts on packaged goods. The device includes a Universal Product Code scanner that scans the bar codes of products on a vendor's shelves, a display means which communicate to the user the bar codes of the selected products and related product information. The device also enables wireless connectivity with a database, preferably housed in the vendor's establishment. The database includes customer data files, shopping history profiles, and a control means which computes and communicates to the user discounts offered by the manufacturer, and computes a personal price to that user for a given product. In one embodiment, the device also includes function keys that enable the device to be activated and cleared, and for product indicia to be selected or recalled.

### CROSS-REFERENCE TO RELATED APPLICATIONS

This application is a continuation-in-part of Provisional Application No. 60/249,501, which was filed on Nov. 17, 2000. That application is incorporated by reference herein, to the extent that it is not inconsistent with the present disclosure.

### BACKGROUND OF THE INVENTION

1. Field of the Invention

This invention relates to wireless coupon-dispensing devices, methods and systems that enable users to obtain discounts for retail purchases while shopping.

2. Background Art

Paper coupons and promotional material offering discounts on retail purchases, such as groceries, often appear (frequently in discarded, unwanted form) on a widespread basis in many types of printed media. Paper coupons are relatively expensive to produce and distribute. Additionally, a great deal of time is often wasted because coupons are distributed randomly through newspapers and magazines, for example, to recipients who neither want them nor use them. Further, such advertising media tend to have a low probability of reaching the attention of the prospective buyer. As a result, much of the advertising disseminated in mass mailing and distributed through the mass media ends up as litter which may or may not become recycled.

Against this background, the need has arisen to make available a device and system that eliminates most of the cost and waste associated with paper coupons, while offering certain advantages to consumers, merchants and manufacturers.

About 330 billion paper coupons for discounts on packaged goods were issued in the year 2000, according to the Coupon Council of the Promotional Marketing Association. Only about 4.5 billion were redeemed, with an average face value of $0.77. Two inferences emerge: (1) paper coupons for discounts is a big business; and (2) advertisers are paying the cost to print and distribute about 73 paper coupons (that end up in land fills) for each coupon that is redeemed.

### SUMMARY OF THE INVENTION

In light of this background, it would be desirable to replace paper coupons with electronic coupons.

It would also be desirable to harness recent advantages in radio wave technology to link the advertiser to the shopper through a retail store's cash register, preferably using capabilities that are already present in most supermarkets.

The invention is a method and system for determining the price of a product or service under consideration by a purchaser from a vendor. The method includes providing a device that includes customer identification indicia and a bar code scanner, and connects wirelessly to a database. The device is used to scan a bar code on a selected product or description of a service. The bar code and customer identification indicia are transmitted to the database. An opening signal is sent to the device from the database. The signal is representative of discounts offered. A display on the device reveals what discounts are available on the selected and/or competing products. The discounts appear in display means associated with the device. Customer identification indicia are presented at a checkout location. A closing signal is communicated between the checkout location and the database. The closing signal is provided as input to a module that applies a discount to all applicable purchases. A reimbursement by the manufacturer to the vendor is computed in proportion to the discounts applied by the vendor to the customer. The database is then updated with the customer's most recent purchases.

The invention also includes a personal pricing device including a grip portion and a head portion. The device has means for scanning product indicia. The means for scanning is preferably located in the head portion, whereby a user may scan the bar code of products. The means for display, also associated with the head portion, enables the user to discern the bar codes. One or more function keys may be associated with the grip portion.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a flow chart that depicts a process for determining discounts using a personal pricing device;

FIG. 2 illustrates various details of a personal pricing device according to the present invention;

FIG. 3 is an overview of the disclosed personal pricing system; and

FIG. 4 illustrates the revenue flows that are generated by adopting and using the personal pricing device, method and system of the present invention.

### DETAILED DESCRIPTION OF THE PREFERRED EMBODIMENTS

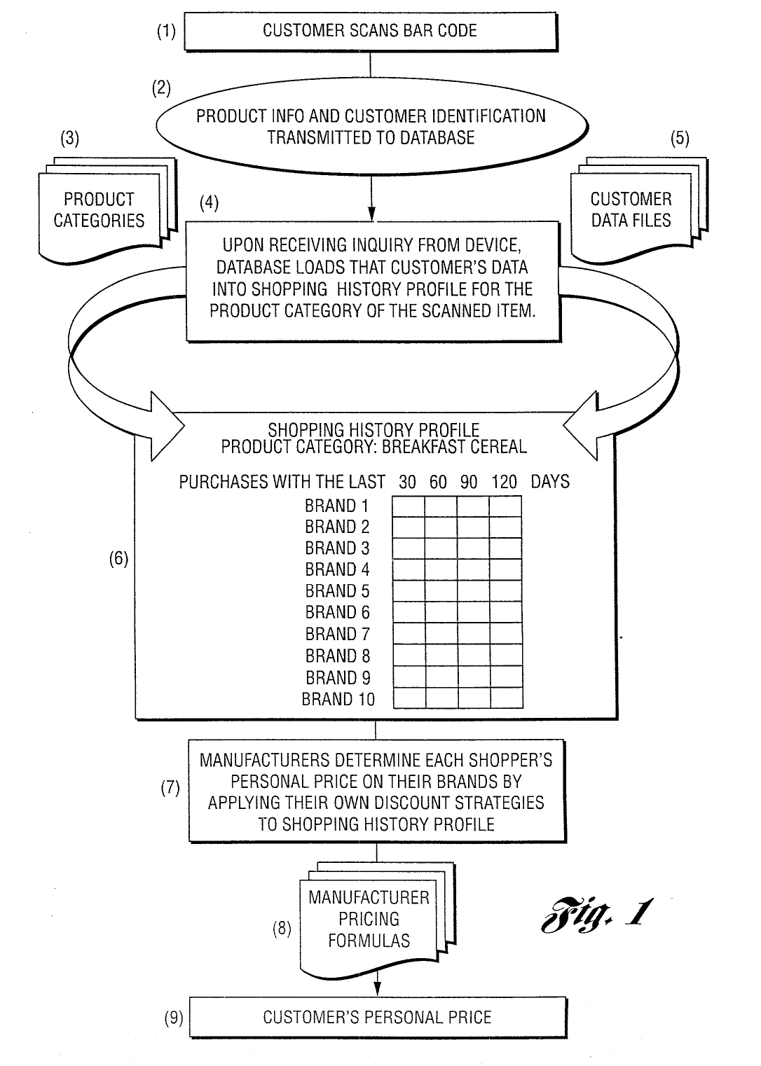

Turning first to FIG. 1 of the drawings, there is depicted a process for determining discounts on products to be purchased from a retail store. To facilitate a description of the invention, reference is made to numerals (1) through (9) that depict various steps and features of the disclosed system.

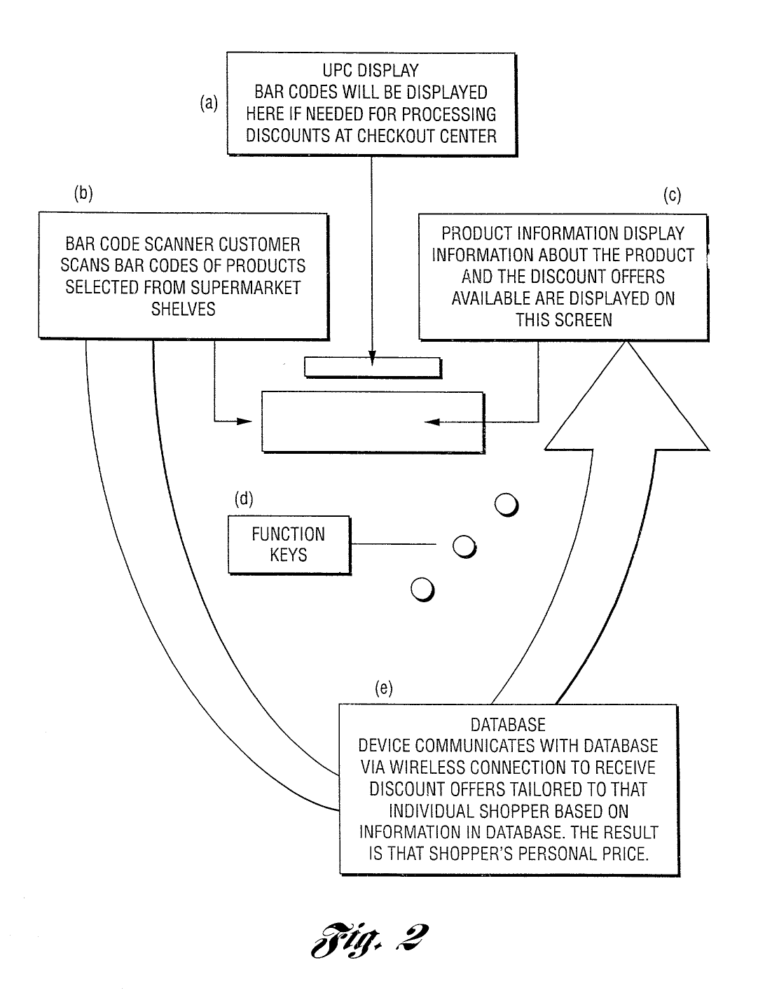

In step (1) of FIG. 1, a customer in a retail store takes a personal pricing device (such as that depicted in FIG. 2) and scans a bar code that uniquely identifies a product which the customer is considering buying. Though an exemplary device is depicted in FIG. 2, it should be realized that the scope of the present invention is not limited to the specific embodiment of the pricing device that is illustrated. In FIG. 2, the personal pricing device includes a window (a) through which the Uniform Product Code (UPC) is displayed. A bar code scanner (b) is included in the device, by which the customer can scan the bar codes of products selected from a retailer's, such as a supermarket's shelves. Box (c) refers to a product information display window through which information about the product and the discount offered is displayed. The bar code scanner (b) communicates with the product information display (c) through control logic which includes a database (e). The function keys (d) enable the user to clear one or all selections, recall selected discounts for redemption at the checkout counter, or select a product that appears on the screen and store that information for recall at the checkout counter, and to activate the device, thereby connecting it to the database. Optionally, thumb-control scrolling enables the user to scroll through a list of available discounts on competing products.

It will be appreciated that the display means for displaying a bar code (FIG. 2, box (a)) may or may not be the same as a display means for displaying information about the product (box (c)).

As indicated, the personal pricing device communicates with a database, preferably by a wireless connection to receive discount offers that are tailored to that individual shopper based on information in the database. The result is that shopper's personal price.

Returning to FIG. 1, after the customer scans the bar code, in step (2), product information and customer identification are transmitted to the database. In step (4), upon receiving an inquiry from the device, the database loads that customer's data into a shopping history profile (step (6)) corresponding to the product category of the scanned item. For example, the shopping history profile may have a product category such as breakfast cereal. Purchases within the last 30, 60, 90, and 120 days are listed in the profile by various brands of breakfast cereal.

To enable such information to be processed, information about various product categories (step (3)) and data files by customer (step (5)) are accessed by or included in the database. The database may reside on a server located in the retail establishment, or in the personal pricing device itself, or partially in both.

In step (7), manufacturers may determine each shopper's personal price on their brands by applying their own discount strategies to the shopping history profile. The manufacturer's pricing formulae (step (8)) are then determined, which result in a calculation of that customer's personal price (step (9)) for a particular product.

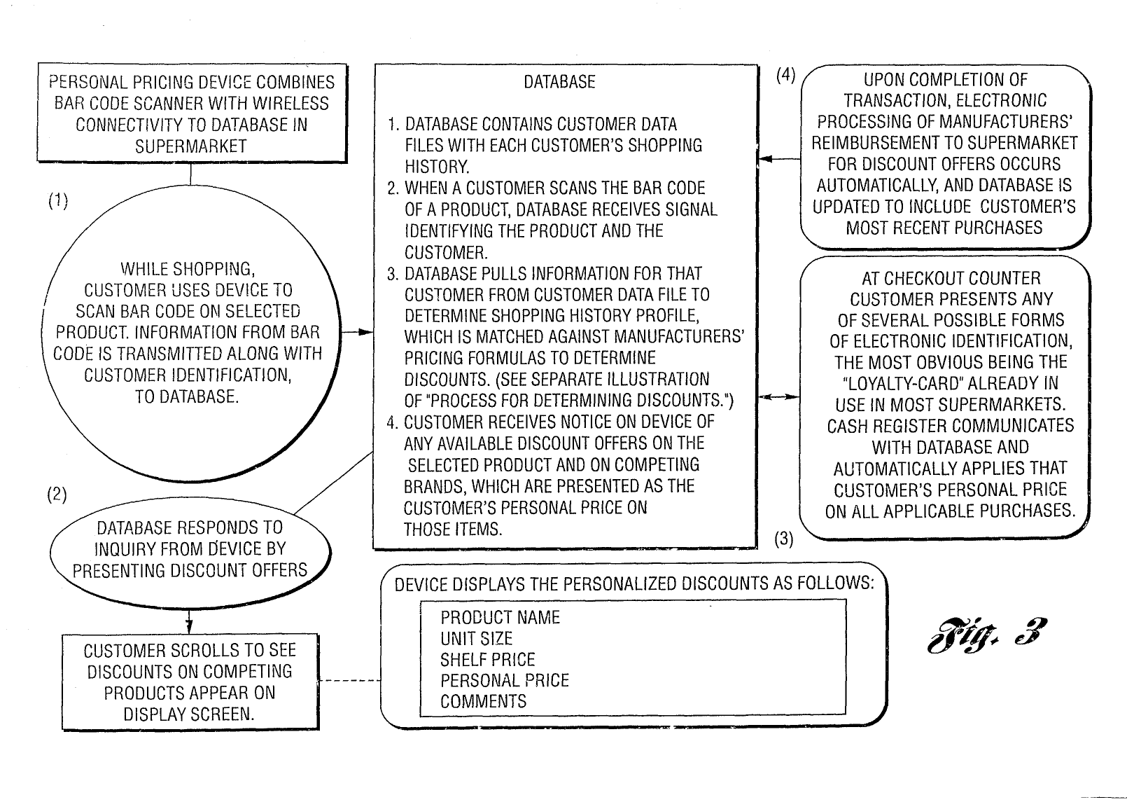

Turning now to FIG. 3, additional information is depicted concerning the personal pricing system. In step (1), the personal pricing device in one embodiment combines the bar code scanner by wireless connectivity to the database in the retail store or supermarket.

In step (2) of FIG. 3, the database responds to the inquiry from the device by presenting discount offers. Using the device, the customer then may scroll to see what discounts are available on competing products, using information that appears on the display screen (c) of FIG. 2. Information such as the following is displayed: product name, unit size, shelf price, personal price, and any comments.

In step (3) of FIG. 3, at the checkout counter, the customer presents any of several possible forms of electronic identification. One possibility is that the customer may have a “loyalty-card” which is already in use at many supermarkets. The cash register then communicates with the database and automatically applies that customer's personal price to all applicable purchases.

In step (4) of FIG. 3, upon completion of the transaction, electronic processing of the manufacturer's reimbursement to the supermarket for discount offers occurs automatically. The database is updated to include the customer's most recent purchases.

As indicated in FIG. 3, the database contains customer data files including each customer's shopping history. When a customer scans the bar code for a given product, the database receives a signal which identifies the product and the customer. The database then retrieves information for that customer from the customer data file to determine the shopping history profile, which is matched against the manufacturer's pricing formulae to determine discounts. Next, the customer receives notice on the device of any available discount offers on the selected product and on competing brands, which are presented as that customer's personal price on those items.

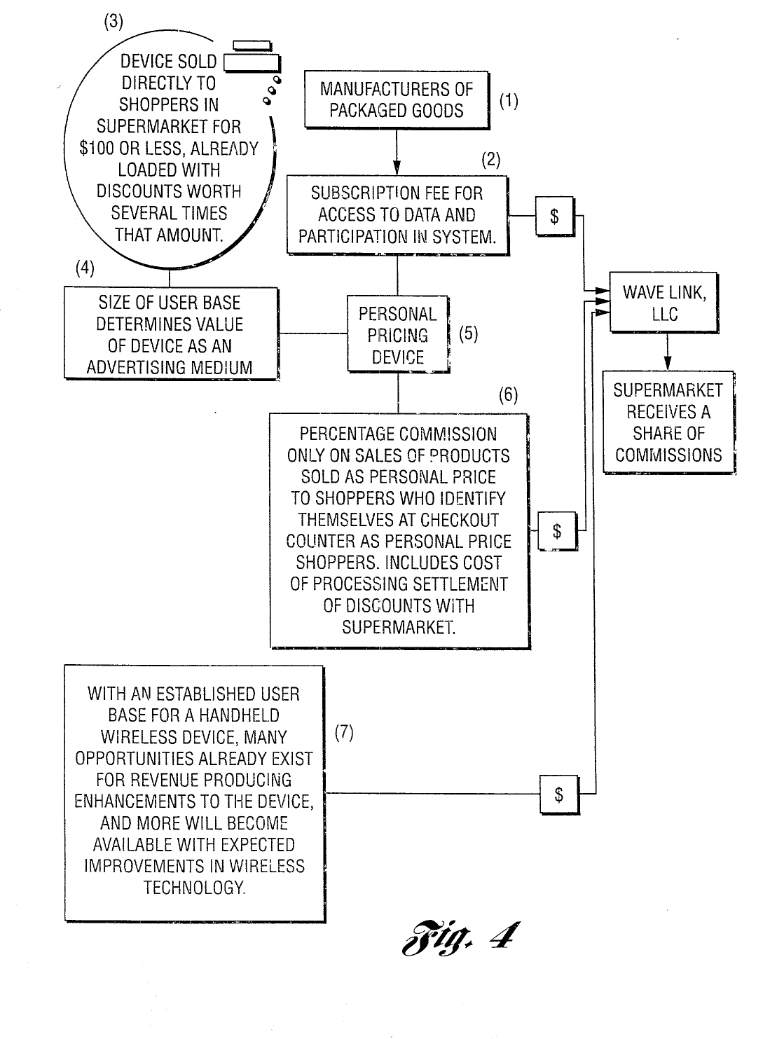

FIG. 4 depicts how the disclosed system generates revenues for the manufacturer, for the retailer, and saves money for the shopper. In steps (1)-(2), manufacturers of packaged goods pay a subscription fee for access to data in the database and for participation in the system.

In steps (3)-(4), the device is sold directly to shoppers in the retail store for about $100 or less, or is loaned or leased. The device may already be loaded with discounts worth several times that amount. It will be apparent, as depicted in step (4), that the size of the user base determines the value of the device as an advertising medium.

In steps (5)-(6), the personal pricing device may optionally include a controller that calculates the percentage commission on the sales of products sold at the personal price to shoppers who identify themselves at the checkout counter as personal price shoppers. The commission would include the cost of processing the settlement of discounts with the supermarket.

Between steps (4)-(7), the system assumes that with an established user base for a handheld wireless device, many opportunities exist for revenue-producing enhancements to the device. It is expected that more will become available with expected improvements in wireless technology. Revenues from steps (2), (6), and (7) flow through an entity, depicted for illustrative purposes as Wave Link, LLC, which may pay a share of the commissions to the retailer.

In light of this disclosure, it will be apparent that a major premise underlying the disclosed invention is that paper coupons used for discounts in retail establishments, such as supermarkets, will be replaced by electronic coupons. Accordingly, the disclosed method and system illustrates how electronic coupons can be delivered to shoppers.

By practicing the disclosed method and system, advertisers will be put in direct contact with individual shoppers without the costs associated with unredeemed paper coupons. The system also achieves the marketing ideal of “dynamic pricing” which allows advertisers to offer variable levels of discounts based on each shopper's individual purchasing history. The combination of cost savings and narrow targeting that the disclosed system makes possible translates into larger discounts, and thus increases the incentive for shoppers to purchase and use the device.

While the best mode for carrying out the invention has been described in detail, those familiar with the art to which this invention relates will recognize various alternative designs and embodiments for practicing the invention as defined by the following claims.

What is claimed is:

1. A method for determining the price of a product or service under consideration by a purchaser from a vendor, the method comprising the steps of:
providing a device that includes customer identification indicia and a bar code scanner, and connects wirelessly to a database;
using the device to scan a bar code on a selected product or description of a service;
transmitting the bar code and customer identification indicia to the database;
sending an opening signal to the device from the database, the signal being representative of discounts offered;
monitoring the device to learn what discounts are available on the selected and/or competing products, the discounts appearing through display means associated with the device;
presenting customer identification indicia at a checkout location;
communicating a closing signal between the checkout location and the database, the closing signal being provided to a module that computes a discount to all applicable purchases;
determining a reimbursement amount to be paid by the manufacturer to the vendor in proportion to the discounts applied by the vendor to the customer; and
updating the database with information about the customer's most recent purchases.

2. The method of claim 1 wherein the database includes customer data files, each having records that define a shopping history of one or more customers.

3. The method of claim 1 further including providing a database means that is in wireless connectivity with the device, the database means including records of shopping history detailed by product category corresponding to a scanned item, and discount offered being tailored to an individual user.

4. A method of using a personal pricing device to generate revenues to a manufacturer and a vendor, the method comprising the steps of:
providing a device to a user, the device including indicia that reflect discounts available;
paying a subscription by the manufacturer to the vendor for access to data and participation in a personal pricing system; and
paying the vendor a share of commissions based on sales made.

5. The method of claim 4 further comprising the steps of:
paying advertising revenue to the vendor, the revenues being effective to purchase advertising media that are communicated through a personal pricing device to a user.

6. A hand-held personal pricing device, comprising:
a grip portion and a head portion;
means for scanning product indicia, the means for scanning being located in the head portion, whereby a user may scan the bar code of products;
means for display, also associated with the head portion, the means for display enabling the user to discern the bar codes; and
one or more function keys associated with the grip portion.

7. The device of claim 6 wherein the means for display includes:
means for displaying bar codes; and
means for displaying information about a product, and the discount offers available.

8. The device of claim 6 wherein the one or more function keys are selected from the group consisting of an activation button, a product selection button, a recall button, and a clear button.

9. The device of claim 6 further including a thumb-controlled means for scrolling associated with the head portion, which allows the user to scroll through a list of available discounts on competing products.
